(19) United States
(12) Patent Application Publication
(10) Pub. No.: US 2005/0011167 A1
(43) Pub. Date: Jan. 20, 2005

(54) Tree for a saddle, an insert for a saddle tree and a saddle tree body

(76) Inventor: Geoffrey Paul Belton, Shropshire (GB)

Correspondence Address: KENYON & KENYON, ONE BROADWAY, NEW YORK, NY, 10004, US

(21) Appl. No.: 10/778,471

(22) Filed: Feb. 12, 2004

(30) Foreign Application Priority Data
Jun. 17, 2003 (GB) 0313965.6
Oct. 23, 2003 (GB) 0324724.4

(51) Int. Cl. B68C 1/02

(52) U.S. Cl. 54/44.1

(57) ABSTRACT

A tree for a saddle having a body and a forwardly disposed bearing part which, when the saddle is mounted on a horse, is located adjacent or close to the horse's withers, the bearing part being releasably attachable to the body, whereby one of a plurality of different bearing parts may be used in association with a given body.

### FIELD OF INVENTION

This invention relates to a tree for a saddle, to an insert for a saddle tree and to a saddle tree body.

### BACKGROUND OF THE INVENTION

As will be well understood by those familiar with the art of saddlery and saddle manufacture, saddle trees constitute the internal “skeleton” of a saddle construction, giving the saddle both strength and flexibility which is needed not only to provide comfort to a horse and its rider but also to ensure that a good “feel” is obtained, whereby the rider is able to control the horse and to respond to the horse's movements. It will be appreciated, of course, that the term “horse” is used here in a very broad sense: thus, for the avoidance of any doubt, the invention relates equally to the field of saddles and saddle trees which conceivably could be used with other animals where the criteria set out above apply in an analogous manner.

Saddle trees, which may be formed from a plastics material using a moulding process, but which more often have a laminated wooden structure, typically comprise a pair of generally longitudinally extending wide, flat pieces known as bars which, in use, lie along each side of the horse's spine. Towards the rear of the tree, the bars are connected by or attached to a cantle, whereas towards the front of the tree, the bars are linked or associated by a head formation or fork.

As the fork, in use, is located in close proximity to the horse's withers, the shape of the front part of the tree is critical in ensuring that the final saddle construction is a good fit for the horse concerned, with approximately 90% of the horse's comfort being decided by the size and shape of this forward portion.

To ensure that appropriately sized and configured saddles are used, it is thus either necessary to produce saddles on a tailor-made basis or to provide some means whereby the fit of a given saddle can be adjusted, with the latter approach having met with varying degrees of success.

EP 0328376 A1, for example, discloses a head plate and tree system for a saddle wherein the head plate “sandwiches” a primary component of the saddle tree, with pivotal plate portions being provided whereby the front part of the tree can be forced to adopt one of a plurality of different conditions. However, the device shown in EP'376 is somewhat limited in that it relies upon an inherent flexibility of the tree body which limits the number of different configurations that can be obtained.

GB 2305592 A, GB 2239158 A and U.S. Pat. No. 5,884,459 each disclose systems whereby the internal configuration of a saddle's fork can be adjusted. GB'592 approaches this by providing a pair of adjustable load bearing members whereby the curve of the members can be altered, but the requirement of an adjustment mechanism and an associated suspension unit makes the construction unduly complicated. GB'158 shows a more complex mechanism still, in that a pair of adjustable, pivotally mounted plates is provided towards the points of the tree. However, it is relatively difficult to adjust the plates to effect a satisfactory degree of movement and the amount of variation that the system permits is somewhat limited. US'459 shows a somewhat similar approach using hinged support plates that are mounted to the underside of a saddle tree, with the plates extending the full length of the tree, thus allowing the overall configuration of the tree's gullet to be varied. However, the solution proposed by US'459 is far from ideal as it does not provide for ready adjustment of the configuration of the most important (forwardly disposed) part of the tree.

It is an object of the present invention to provide a tree for a saddle that overcomes or at least reduces these and other drawbacks. It is also an object of the present invention to provide an improved insert for a saddle tree and to provide an improved saddle tree body.

### SUMMARY OF THE INVENTION

In accordance with a first aspect of the present invention, there is provided a tree for a saddle having a body and a forwardly disposed bearing part which, when the saddle is mounted on a horse, is located adjacent or close to the horse's withers, the bearing part being releasably attachable to the body, whereby one of a plurality of different bearing parts may be used in association with a given body.

The bearing part may be associated with an engagement part, which, in use, engages a receiving part of the body, whereby said releasable attachment may be effected.

The engagement part preferably is integral with the bearing part. Two bearing parts may be provided for location, in use, either side of the horse's withers and the two bearing parts may be connected by the engagement part.

The bearing parts may be associated with the points of the tree and the engagement part, in use, may provide at least part of the tree head.

The receiving part may be provided by a bridging element connecting the forwardly disposed ends of the tree bars.

The bridging element preferably has a generally concave receiving surface, the engagement part desirably having a similarly configured, generally convex, engagement surface.

The receiving part may have a stop which, in use, abuts a shoulder disposed between the bearing part and engagement part, whereby the engagement part may be located in position in relation to the receiving part.

The stop may be provided by an edge portion of the receiving part.

The bearing part and the engagement part may together provide a generally bell-shaped insert, the insert being releasably attachable to the body.

In accordance with a second aspect of the present invention, there is provided an insert for a saddle tree having a bearing part which, in use, is located adjacent or close to a horse's withers, and an engagement part configured for releasable attachment to the body of the tree, whereby one of a plurality of different inserts may be used in association with a given body.

Two bearing parts may be provided, conveniently being connected by a bridging element.

The bridging element may have an outwardly facing surface, which, in use, abuts an inwardly facing surface of a receiving part of the body.

The outwardly and inwardly facing surfaces may each be generally arcuate.

The insert may have a shoulder which, in use, abuts a stop of the receiving part. The insert may conveniently be bell-shaped.

The invention, in its second aspect, may comprise one or more of the features described in relation to the first aspect of the present invention.

In accordance with a third aspect of the present invention, there is provided a saddle tree body having, towards a front part thereof, a receiving part adapted for releasable attachment to an engagement part of a separate bearing part, the bearing part, in use, being located adjacent or close to a horse's withers, the saddle tree thus constituting one element of a two-element assembly, in that one of a plurality of different bearing parts may be used in association with the body, allowing a given bearing part to be replaced by another.

The invention, in its third aspect, may comprise one or more of the features of the first two aspects of the present invention.

In accordance with a fourth aspect of the present invention, there is provided a saddle incorporating one or more features of the first three aspects of the present invention.

In accordance with a fifth aspect of the present invention, there is provided a head component for a saddle tree, the head component having a bearing part which, in use, is located adjacent or close to a horse's withers, and an engagement part configured for releasable attachment to the body of the tree, whereby one of a plurality of different head components may be used in association with a given body.

In this way, a modular arrangement may be provided, in which a given head component may, if desired, be substituted for a different head component, to suit a different rider, riding style or horse, for example.

Two bearing parts may be provided, conveniently being connected by a bridging element.

The bridging element may have an inwardly facing surface, which, in use, abuts an outwardly facing surface of a receiving part of the body.

The inwardly and outwardly facing surfaces may each be generally arcuate.

The head component may have a rearwardly-disposed edge which, in use, abuts a stop of the receiving part. The stop may be provided by a step formation. The head component may conveniently be bell-shaped.

The invention, in its fifth aspect, may comprise one or more of the features described above.

### DESCRIPTION OF THE DRAWINGS

Specific and non-limiting embodiments of the invention, in its various aspects, will now be described in greater detail, but strictly by way of example only, by reference to the accompanying drawings, of which:

FIG. 1 is a side view of a saddle tree body and associated bearing part, in a separated condition;

FIG. 2 is a perspective view from above of the components shown in FIG. 1;

FIG. 3 is a side view of the components in an assembled condition;

FIG. 4 is an end-on view of the bearing part;

FIG. 5 is a perspective view, from above, of a second embodiment of saddle tree body and bearing part, in a separated condition;

FIG. 6 is a similar view of the components of FIG. 5, this time in an assembled condition;

FIG. 7 is a view, from below, of the components of FIG. 5;

FIG. 8 is a view, from below and from the front, of the assembled construction of FIG. 6; and

FIG. 9 is a side view of the components of FIGS. 5 to 8, in an assembled condition.

### DETAILED DESCRIPTION OF THE INVENTION

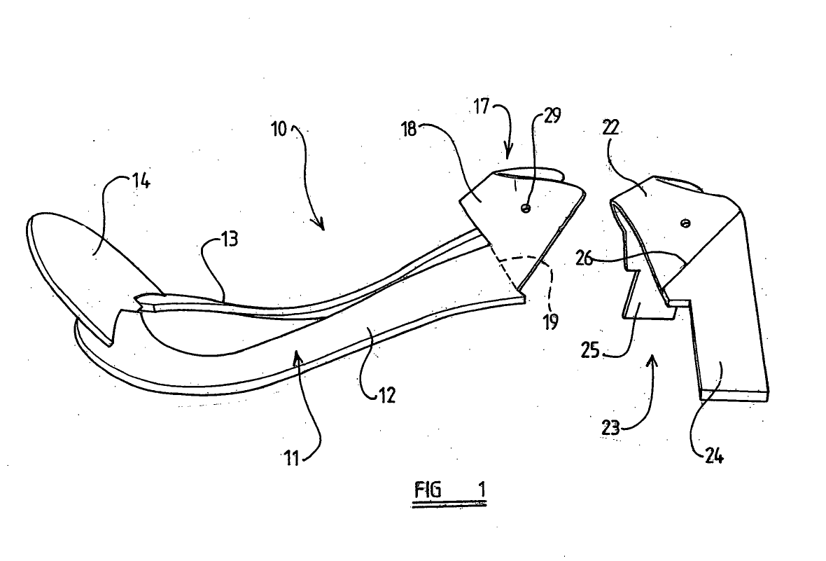

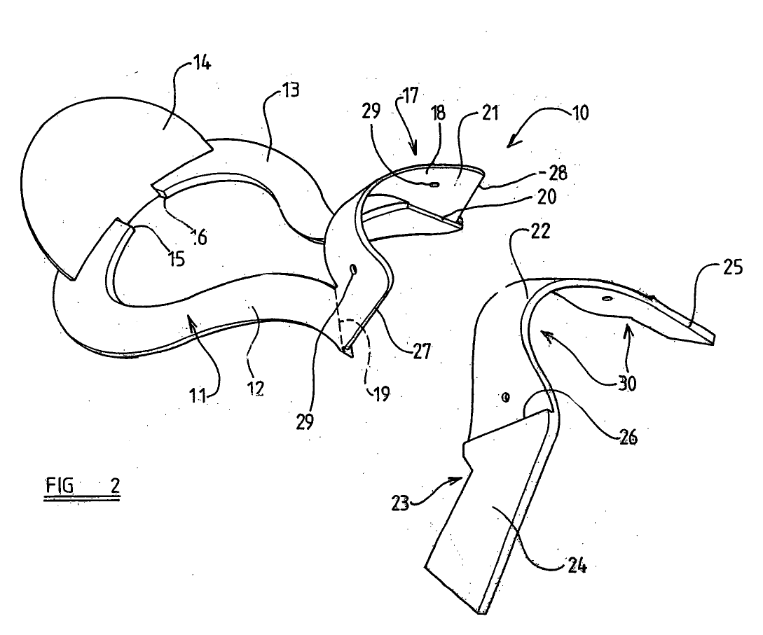

Referring first to FIGS. 1-4, a saddle tree 10 is shown having a body 11 which, in conventional manner, comprises a pair of generally longitudinally extending bars 12 and 13 and a rearwardly disposed cantle 14 which spans the distal ends 15 and 16 of the bars, and thus constitutes an interconnecting bridging element of the tree. It will be appreciated that the cantle can be secured to the bars in a number of conventional ways, none of which is relevant to the present invention. The front part 17 of the tree comprises a generally arcuate bridging element 18 which is integral with the free ends 19 and 20 of the tree arms, with the bridging element being somewhat thinner (see FIG. 2 especially) than the distal parts 19 and 20. The internal surface 21 of the bridging element constitutes a receiving part which, in use, receives an outwardly facing engagement part 22 of a bearing part 23 of the tree assembly. The bearing part 23, like the body 11, is of generally laminar construction, with the free ends 24 and 25 thereof being somewhat thicker than the generally arcuate engagement part 22. This difference in thickness provides a pair of shoulders 26 which, when the bearing part 23 is attached to the tree body, abut the free edges 27 and 28 of the receiving part 21, thus enabling the bearing part 23 to be located in position in relation to the body.

The engagement part 22 is configured so as to fit closely with the receiving part 21, with attachment of the two parts being effected using simple threaded fasteners inserted through apertures 29. It will however be appreciated that the fastening manner does not form part of the present invention, and that a number of other types of fastening device could easily be employed.

As shown clearly in the drawings, the detachable nature of the bearing part 23 provides the tree with a great degree of interchangability, in that the bearing part can easily be replaced with another, if so required. In this regard, a plurality of different bearing parts can be provided, each of which having a generally similar engagement part 22, but each differing insofar as the internal configuration (shown generally at 30) is concerned.

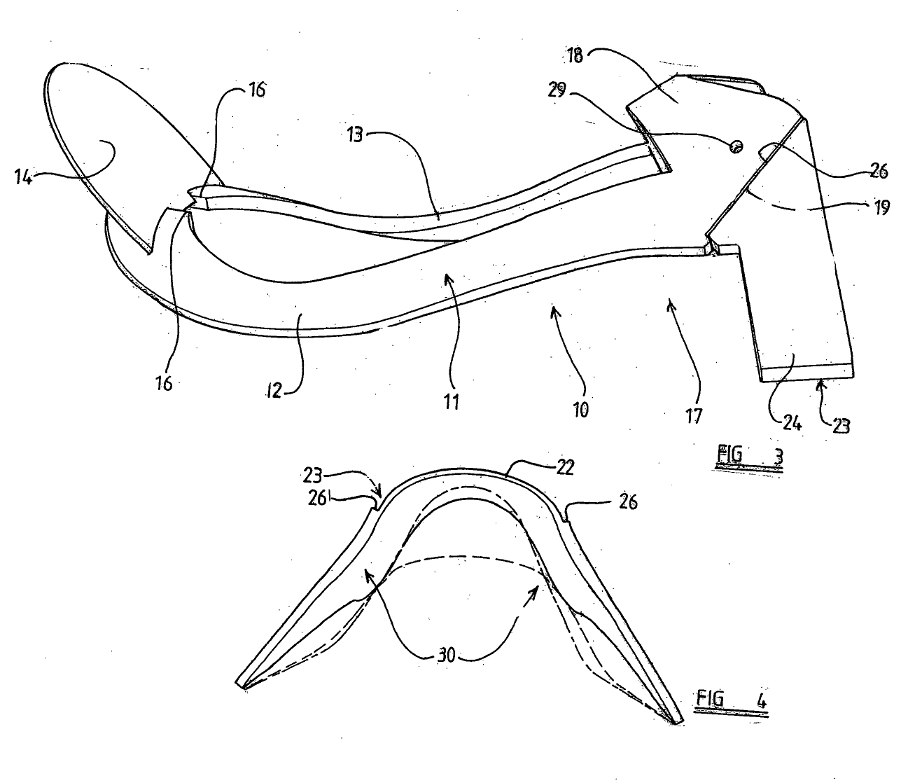

Thus, as shown in FIG. 4, the internal configuration 30 of the bearing part 23 is selected in accordance with the dimensions of the horse concerned. The bearing part shown in solid outline in FIG. 4 represents that which may be suitable for a relatively young, small horse, whereas a bigger horse having a wider spine and relatively lower withers would benefit from the use of a modified bearing part such as that shown in dotted outline in FIG. 4. On the other hand, a tall but relatively slender horse, having higher withers but a narrower spine, would benefit from the use of a third configuration of bearing part such as that shown in chain dotted outline in FIG. 4.

It is important to appreciate that, in each of the three different configurations shown in FIG. 4, the outwardly facing engagement part 22 remains the same, thus ensuring that each replaceable part fits well with the body of the tree.

From the above, it will be clear that the invention provides a radically new approach to the design and manufacture of saddle trees, in that it allows a unitary or modular tree body to be produced in conjunction with a range of different bearing parts from which one may be selected in accordance with a horse's and/or a rider's requirements.

As no complex attachment facilities are required, and as the mutually configured engagement and receiving parts ensure a good, secure fit between the bearing part and the body, the components, when assembled, are maintained firmly in position, thus ensuring that the “feel” of the horse by the rider is not compromised.

Moreover, as the invention allows a tailor-made saddle to be produced principally by selection or manufacture of a dedicated and carefully shaped bearing part, the cost of manufacturing a personalised saddle is greatly reduced, and the manufacturing process considerably simplified.

The saddle tree and component parts thereof, as described herein, may be formed from a wooden (e.g. laminated) structure or may alternatively be produced from plastics mouldings or extrusions. Carbon fibre materials may also be suitable.

FIGS. 5 to 9 illustrate an alternative construction of saddle tree and bearing part, in which a similar numbering system has been adopted, with parts corresponding to those shown in FIGS. 1 to 4 being numbered similarly, with the addition of 100.

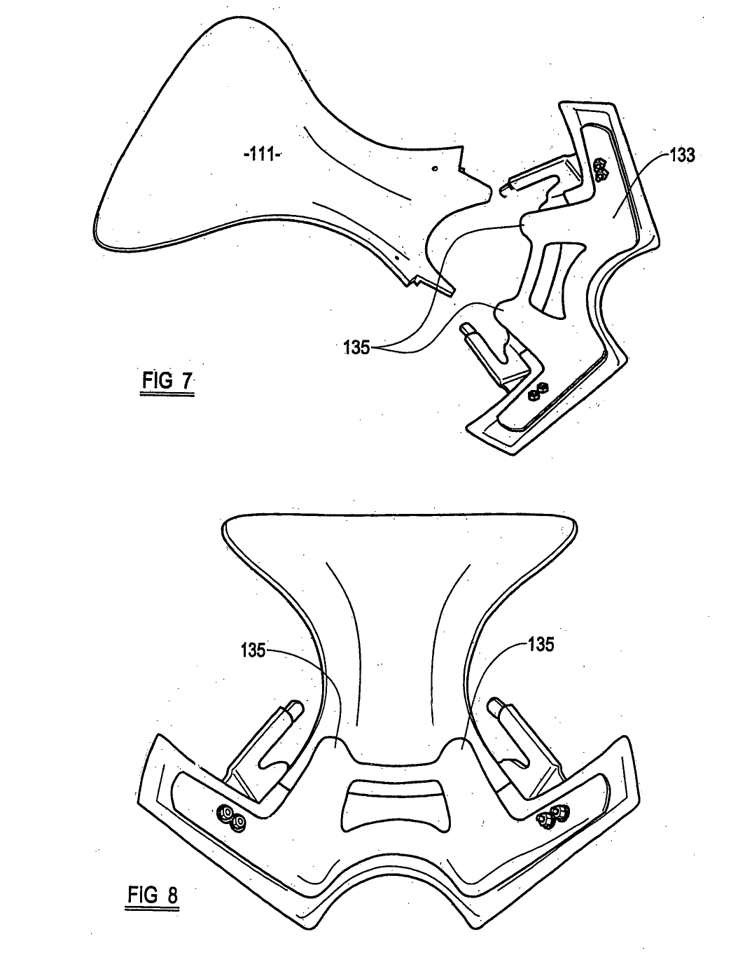

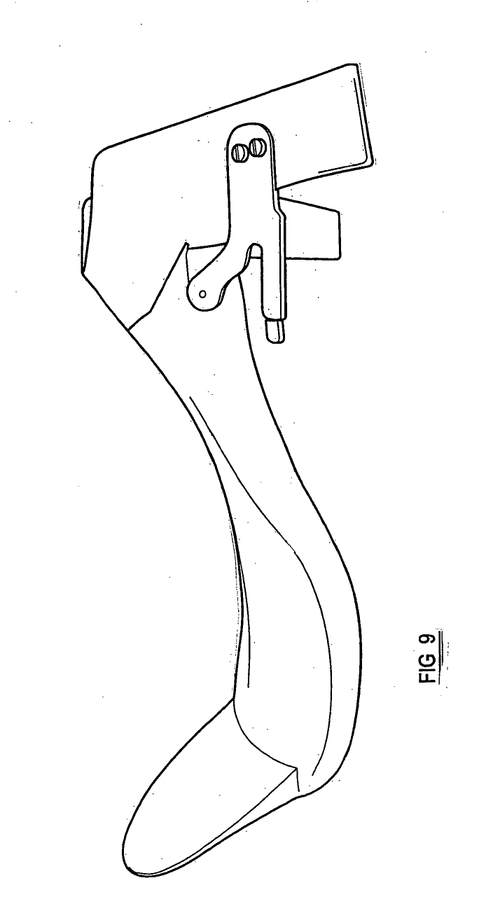

FIG. 5 thus illustrates an alternative construction of saddle tree having a body 111 which, in contrast to the body 11 shown in the preceding figures, is of a generally solid construction, as opposed to the bar-based construction of the previous embodiment. The front part 117 of the tree 110 has a forwardly-disposed and generally arcuate receiving part 121 having a forward edge 121a and a rearward edge 121b, defined by a step/ledge in the body 111. Corners 111a and 111b of the body 111 are provided with recessed guides 111c and 111d which, in use, receive locating bars 131 of stirrup bar assemblies 132 which are securely (but removeably) attached to a bearing part 123 of the tree assembly, towards its free ends 124 and 125. The bearing part 123 has a generally arcuate engagement part 122 which, in use, snugly overlies the receiving part 121 of the tree body 111, with the rearward edge 122a of the engagement part abutting the step 121b at its limit of travel. As shown more clearly in FIGS. 7 and 8, the bearing part 123 is provided, on its underside, with a metallic (in this case stainless steel) strengthening element (gullet plate) 133, to give the bearing part rigidity and to assist in the correct alignment of the bearing and receiving parts.

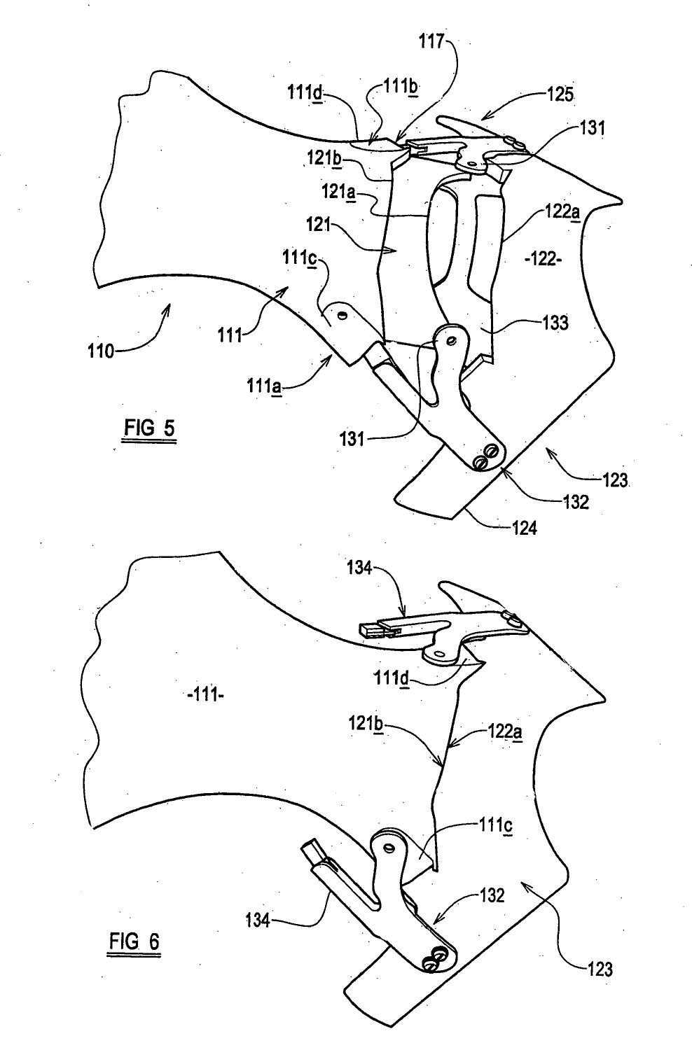

As shown in FIG. 6, attachment of the bearing part 123 to the body 111 causes the rearward edge 122a of the engagement part 122 to come into close contact with (and abut) the step 121b, resulting in a near seamless join and causing the locating bars 131 to slide into the channels 111c and 111d. At this point, it will be understood that the frictional engagement of the locating bars 131 with the recesses 111c and 111d has the effect of clamping the engagement part 122 of the bearing part 123 to the receiving part 121 of the tree body 111, thus resulting in a stiff and secure construction. It can be seen, also, that the stirrup bars 134 play no direct part in the attachment mechanism, remaining free for reception of the stirrup straps, in generally conventional manner.

FIG. 7 shows the components of FIGS. 5 and 6, in a separated condition, from below. From this, it can be seen that the strengthening element 133 has a somewhat W-shape, with the central parts 135 of the “W” extending generally rearwardly, such that they will lie closely beneath (and in contact with) a forwardly disposed part of the tree 111, when the components are assembled, as per FIG. 6. FIG. 8 shows the components of FIG. 7 in their assembled condition, from which it can be seen that the central parts 135 are disposed beneath (and in contact with) the underneath surface of the tree 111. Although not germane to the present invention, it can be seen that the strengthening element 133 is somewhat rounded on its exposed surfaces, to reduce the possibility of any discomfort or snagging that might occur with padding or the like that may be placed between the saddle tree and the horse's withers. The strengthening element 133, in this example, is attached to the bearing part 123 using two opposed pairs of nut/bolt arrangements, although other attachment methods could equally well be employed.

Looking lastly at FIG. 9, this shows the assembled tree (of FIGS. 5 to 8), in side view, from which it can be seen that the stirrup bars adopt a generally horizontal orientation once the bearing part 123 has successfully been attached to the body 111, with the stirrup bar assemblies thus serving not only to assist in locating the bearing part 123 on the body 111, but also to provide apertures through which the nuts of the nut/bolt pairs of FIG. 8 may pass.

As with the embodiment shown in FIGS. 1 to 4, the tree body and bearing part may be formed from wood, a laminated wooden construction or from a plastics or carbon fibre material, with the applicant having found that a polypropylene body and bearing part is particularly satisfactory, from a rigidity, durability and manufacturing tolerance point of view.

It is envisaged that a range of at least six different bearing parts could be provided, so as to give both saddle manufacturers and retailers great variety in the number of saddle options that can be made available. In hand with that, great cost savings can be made as it is no longer necessary to manufacture complete saddle tree units, with it instead being sufficient to stock a supply of standard tree bodies and a selection of bearing parts. Where the components are produced (at least predominantly) from a polypropylene plastics material, modern moulding techniques allow the parts to be produced to a high degree of accuracy, meaning that a high quality “fit” between the tree body and bearing parts will always be available, thus reducing the possibility of any “give” or slip, during use.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A tree for a saddle having a body and a forwardly disposed bearing part which, when the saddle is mounted on a horse, is located adjacent or close to the horse's withers, the bearing part being releasably attachable to the body, whereby one of a plurality of different bearing parts may be used in association with a given body.

2. A tree according to claim 1 wherein the bearing part is associated with an engagement part which, in use, engages a receiving part of the body whereby said releasable attachment may be effected.

3. A tree according to claim 2 wherein the engagement part is integral with the bearing part.

4. A tree according to claim 3 wherein two bearing parts are provided for location, in use, either side of the horse's withers and wherein the two bearing parts are connected by the engagement part.

5. A tree according to claim 4 wherein the bearing parts are associated with the points of the tree and wherein the engagement part, in use, provides at least part of the tree head.

6. A tree according to claim 5 wherein the receiving part is provided by a bridging element connecting the forwardly disposed ends of the tree bars.

7. A tree according to claim 6 wherein the bridging element has a generally concave receiving surface and wherein the engagement part has a similarly configured, generally convex, engagement surface.

8. A tree according to claim 7 wherein the receiving part has a stop which, in use, abuts a shoulder disposed between the bearing part and engagement part whereby the engagement part may be located in position in relation to the receiving part.

9. A tree according to claim 8 wherein the stop is provided by an edge portion of the receiving part.

10. A tree according to claim 9 wherein the bearing part and the engagement part together provide a generally L-shaped insert, releasably attachable to the body.

11. An insert for a saddle tree having a bearing part which, in use, is located adjacent or close to a horse's withers, and an engagement part configured for releasable attachment to the body of the tree, whereby one of a plurality of different inserts may be used in association with a given body.

12. An insert according to claim 11 wherein two bearing parts are provided, the bearing parts being connected by a bridging element.

13. An insert according to claim 12 wherein the bridging element has an outwardly facing surface which, in use, abuts an inwardly facing surface of a receiving part of the body.

14. An insert according to claim 13 wherein both surfaces are generally arcuate.

15. An insert according to any one of claim 14 having a shoulder which, in use, abuts a stop of the receiving part.

16. An insert according to any one of claim 15 which is generally bell-shaped.

17. A saddle tree body having, towards a front part thereof, a receiving part adapted for releasable attachment to an engagement part of a separate bearing part, the bearing part, in use, being located adjacent or close to a horse's withers, the saddle tree thus constituting one element of a two-element assembly, in that one of a plurality of different bearing parts may be used in association with the body, allowing a given bearing part to be replaced by another.

18. A head component for a saddle tree, the head component having a bearing part which, in use, is located adjacent or close to a horse's withers, and an engagement part configured for releasable attachment to the body of the tree, whereby one of a plurality of different head components may be used in association with a given body.

19. A saddle comprising the tree as recited in claim 1.
